(19) United States
(12) Patent Application Publication
(10) Pub. No.: US 2025/0209320 A1
(43) Pub. Date: Jun. 26, 2025

(54) A HARDWARE SYSTEM COMPRISING A NEURAL NETWORK AND A METHOD FOR OPERATING SUCH A HARDWARE SYSTEM

(71) Applicant: KING'S COLLEGE LONDON, London, Greater London (GB)

(72) Inventors: Osvaldo SIMEONE, London (GB); Bipin RAJENDRAN, London (GB)

(21) Appl. No.: 18/849,410

(22) PCT Filed: Mar. 20, 2023
(86) PCT No.: PCT/GB2023/050700

§ 371 Date: Sep. 20, 2024

(30) Foreign Application Priority Data
Mar. 21, 2022 (GB) 2203877.2

(51) Int. Cl. G06N 3/08; G06N 5/04

(52) U.S. Cl. CPC G06N 3/08; G06N 5/04

(57) ABSTRACT

A hardware system is provided which includes a neural network. The neural network comprises nodes interconnected by synapses implemented by respective hardware devices. The hardware devices are configured to generate an output by performing an inference operation using the neural network. The operation of the synapses is controlled by setting a physical property of the respective hardware devices implementing the respective synapses, at least one of setting or reading the physical property being subject to noise. The neural network associates probabilistic weight distributions with respective synapses. Setting the physical property of a given synapse comprises applying a weight value sampled from the weight distribution corresponding to that synapse. Performing the inference operation comprises performing multiple inference determinations using multiple respective sampled weight values for the synapses to obtain multiple inference results. The multiple inference results indicate a confidence interval for the output of the inference operation. The use of multiple inference determinations acts further to suppress the effect of noise for at least one of setting or reading the physical property of the synapses. Such a hardware system may also be used for generating and training the neural network.

### FIELD

The present invention relates to a hardware system comprising a neural network, the neural network comprising nodes interconnected by synapses implemented by respective hardware devices, and to a method of operating such a hardware system.

### BACKGROUND

A typical neural network comprises an input, a network of interconnected of nodes, and an output. The network of nodes may be arranged, for example, in a series of layers. The network input receives input signals that propagate through the nodes to arrive at the output. The connections between the nodes are associated with respective weights, whereby the weight of a connection between first and second nodes determines the strength of signal propagation between these two nodes. Accordingly, the output produced for a given data input depends on the weights associated with the various connections in the network. These weights (which are sometimes referred to as synaptic weights) can therefore be considered as parameters defining a neural network model.

The deployment and use of such a network typically involves two stages. In the first stage, the network is trained using input data for which there is a known (desired) output. The actual output as produced by the network is compared with the desired output, and the difference is used in a feedback process to update the model parameters (connection weights) to align the actual output with the desired output. The second stage is generally referred to as inference, and involves the trained model receiving input data and producing output according to the trained model parameters.

Neural networks and other types of machine learning (ML) system are increasingly employed in many different areas, including artificial intelligence (Al), decision-making, and so on. However, current machine learning systems have certain problems, including: (1) they consume huge amounts of time and energy to optimise the models, and (2) they are unable to efficiently assign confidence metrics to the decision they provide. The former limits the adaptation of AI technologies, especially in embedded applications that require learning or inference to be conducted in the field with limited power budgets and without connecting to centralised servers. Thus many AI solutions available today require the transmission of user data to central cloud servers where analysis is performed, with the results then being returned to the user. This approach has privacy and security concerns, as well as requiring communications resources that may not be available for all devices.

The paper “Brain-inspired computing—We need a master plan” by A. Mehonic & A. J. Kenyon (https://arxiv.org/ftp/arxiv/papers/2104/2104.14517.pdf) describes neuromorphic computing which looks to biology to inspire new ways to process data. One example of neuromorphic computing involves co-locating storage and computing, as the brain does, to avoid shuffling data constantly between processor and memory (as implemented by CMOS transistors). This can be achieved using memristors, which are usually implemented as two terminal electronic devices whose resistance is a function of their history. Such neuromorphic computing may help to significantly reduce energy consumption of electronic devices, which is especially attractive for small electronic devices such as utilised in the Internet of Things (IOT). Further details about memristors can be found in: “Memristors—From In-Memory Computing, Deep Learning Acceleration, and Spiking Neural Networks to the Future of Neuromorphic and Bio-Inspired Computing”, by Adnan Mehonic, Abu Sebastian, Bipin Rajendran, Osvaldo Simeone, Eleni Vasilaki, and Anthony J. Kenyon, in Advanced Intelligent Systems, 2020, 2, 2000085.

There is interest in further development of AI and ML systems, for example to address at least some of the problems identified above.

### SUMMARY

A hardware system is provided which includes a neural network. The neural network comprises nodes interconnected by synapses implemented by respective hardware devices. The hardware devices are configured to generate an output by performing an inference operation using the neural network. The operation of the synapses is controlled by setting a physical property of the respective hardware devices implementing the respective synapses, at least one of setting or reading the physical property being subject to noise. The neural network associates probabilistic weight distributions with respective synapses. Setting the physical property of a given synapse comprises applying a weight value sampled from the weight distribution corresponding to that synapse. Performing the inference operation comprises performing multiple inference determinations using multiple respective sampled weight values for the synapses to obtain multiple inference results. The multiple inference results indicate a confidence interval for the output of the inference operation. Such a hardware system may also be used for generating and training the neural network.

In some implementations, the neural network is a Bayesian spiking neural network, the weight values are binary, and the weight distributions are binomial or Gaussian (or any other suitable long-tailed distribution, such as log-normal or Weibull). In some cases, the spikes of the spiking network may be binary, or they may values taken from any other set of multiple discrete values-for example, the spikes might have a value of ±1, or be selected from the set of values 0, 1, 2 and 4. In some implementations, the hardware system is configured as a crossbar array. The hardware device for each synapse may comprise a memristor and the physical property may comprise conductance.

Performing multiple inference determinations may comprise successively performing multiple inference determinations with different sampled weight values for the synapses on the same hardware device and/or performing multiple inference determinations with different sampled weight values for the synapses on multiple respective hardware devices.

In some implementations, a weight distribution is mapped onto the noise associated with the physical property, such that reading the physical property inherently provides a sample weight value of the weight distribution. One or more control operations may be performed on the hardware device for a synapse to adjust the noise associated with the hardware device to match the weight distribution for the synapse. In other cases, a synapse may be formed from a circuit comprising multiple hardware devices configured such that the weight distribution can be mapped onto the noise associated with the circuit.

A hardware system (which may be the same as or different from the hardware system specified above) is provided for training a neural network. The neural network comprises nodes interconnected by synapses implemented by respective hardware devices in the hardware system. Operation of the synapses is controlled by setting a physical property of the respective hardware devices implementing the respective synapses, at least one of setting or reading the physical property being subject to noise. The neural network associates probabilistic weight distributions with respective synapses, wherein setting the physical property of a given synapse comprises applying a weight value sampled from the weight distribution corresponding to that synapse. The hardware system is configured to map the weight distribution to the noise of setting or reading the physical property, and to implement sampling from the weight distribution by setting or reading the physical property subject to noise.

In some implementations, the neural network is a Bayesian spiking neural network, the weight values are binary, the weight distributions are binomial or Gaussian, and the hardware system is configured as a crossbar array. The hardware device for each synapse may comprise a memristor and the physical property may comprise conductance.

In some implementations, one or more control operations may be performed on the hardware device for a synapse to adjust the noise associated with the hardware device to match the weight distribution for the synapse. In other cases, a synapse may be formed from a circuit comprising multiple hardware devices configured such that the weight distribution can be mapped onto the noise associated with the circuit.

Also provided are methods for operating such hardware systems.

The approach described herein offers various advantages (according to the particular implementation). For example, the use of weight distribution functions allows the decision engine during inference to provide not only a decision, but also a confidence metric associated with that decision. In addition, an architectural implementation based on spiking neural networks and binary weights is highly efficient in that forward propagation does not require multiplication operations. Furthermore, the stochasticity in the characteristics of memristive devices is no longer treated as a nuisance to be mitigated, but instead is transformed into a resource that is used to implement efficiently the Bayesian sampling of the weight distributions.

### BRIEF DESCRIPTION OF THE FIGURES

Various implementations of the claimed invention will now be described by way of example only with reference to the following drawings.

FIG. 1 is a schematic diagram showing a simplified example of (i) a deterministic Deep Learning (DL) neural network (left portion) and (ii) a Bayesian (Probabilistic) Spiking Neural Network (SNN) as used in the present disclosure.

FIG. 2 is a plot of using a SNN such as shown in FIG. 1 to perform a standard 1D regression task, including the generation of a standard deviation to indicate a confidence interval for the regression.

FIG. 3 is a schematic diagram of part of a crossbar array which may be used to implement an SNN according to the present disclosure.

FIG. 4 is a schematic diagram showing multiple layers mapped to crossbar arrays which may be used to implement a neural network according to the present disclosure.

FIG. 5 is a schematic diagram showing further details of the multiple layers shown in FIG. 4 which may be used to implement a neural network according to the present disclosure.

FIG. 6 is another schematic diagram showing multiple layers and cores forming part of a crossbar array which may be used to implement a neural network according to the present disclosure.

FIG. 7 shows an example of the physical layout of the layers and cores of FIG. 6 which may be used to implement a neural network according to the present disclosure.

FIG. 8 is a schematic diagram of part of a crossbar array which is a variation on that shown in FIG. 3 and which may also be used to implement an SNN according to the present disclosure.

FIG. 9 is a schematic diagram of a memristor 330 which may be used in a hardware implementation of a neural network such as shown in FIGS. 3-8 according to the present disclosure.

FIG. 10 is a flowchart of an example method for creating and using a hardware implementation of a neural network such as shown in FIGS. 3-9 according to the present disclosure.

FIG. 11 is a flowchart of an example method for creating and using a hardware implementation of a neural network in which the distribution of weights is implemented using one or more noise processes in the hardware according to the present disclosure.

FIG. 12 is a high-level schematic diagram showing the training of a neural network and then the use of the trained neural network for performing inference. The inference operation involves performing forward propagation of the input through the hardware system multiple times to determine a profile of decisions.

FIG. 13 is a schematic diagram showing the training of a neural network and then the use of the trained neural network for performing inference according to the present disclosure. The the inference operation involves performing forward propagation of the input through multiple copies of the hardware system in parallel to determine a profile of decisions.

FIGS. 14A and 14B (collectively referred to as FIG. 14) are schematic diagrams showing how the hardware system of FIGS. 3-9 can be used for training and implementing a neural network according to the present disclosure.

FIG. 15 is a flowchart of an example method for training a neural network model implemented in hardware such as shown in FIG. 14 according to the present disclosure.

### DETAILED DESCRIPTION

Disclosed herein is an architecture which (in one implementation) employs a hardware platform comprising nanoscale 2-terminal or 3-terminal memristive devices in a crossbar array to perform inference and/or on-chip learning using Bayesian spiking neural networks.

In this approach for inference, the spiking neural network may be designed and trained in traditional microprocessors (e.g. in a standard computer) using software tools. The spiking neural network parameters obtained after software training are then transferred to the hardware platform. In some cases, multiple devices may be used to implement the synaptic weight, in other cases, there may be just one device per synaptic weight. During inference operation, forward propagation of the inputs through the network is performed to obtain a decision.

In this approach for on-chip learning the spiking neural network is trained in the hardware platform itself, with very limited interactions with central servers. In some cases, multiple devices may be used to implement the synaptic weight (although it is also possible to use one device per synaptic weight).

One algorithmic framework which has been adopted in some implementations to train spiking neural networks using Bayesian methods is disclosed in: “BISNN: Training Spiking Neural Networks with Binary Weights via Bayesian Learning” by Hyeryung Jang, Nicolas Skatchkovsky, and Osvaldo Simeone (https://arxiv.org/pdf/2012.08300.pdf). As described in this paper, an Artificial Neural Network (ANN)-based inference on battery-powered devices can be made more energy-efficient by restricting the synaptic weights to be binary (i.e. 31 1 or +1, but with no intervening options), hence eliminating the need to perform multiplications. An alternative, emerging, approach relies on the use of Spiking Neural Networks (SNNs), which are based on biologically inspired, dynamic, event-driven models that enhance energy efficiency via the use of binary, sparse, activations. The above paper sets out an SNN model which combines the benefits of binary weights and temporally sparse binary activations to provide a binary SNN (BISNN) in which each synaptic weight can only take one of two possible values (−1 and +1). BiSNNs are particularly well suited for hardware implementations on chips with nanoscale components that provide discrete conductance levels for the synapses. Two learning rules are derived, the first based on the combination of straight-through and surrogate gradient techniques, and the second based on a Bayesian paradigm. Experiments are used to validate the performance loss with respect to full-precision implementations and demonstrate the advantage of the Bayesian paradigm in terms of accuracy and calibration.

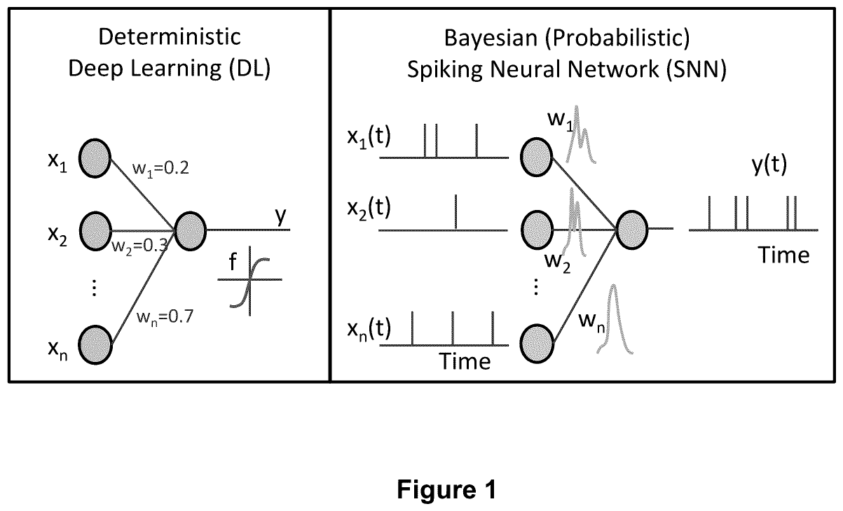

FIG. 1 is a schematic diagram comparing a Bayesian (Probabilistic) Spiking Neural Network (right) with a deterministic Deep Learning (DL) network (left). The latter represents a common (standard) architecture for a neural network, and shows n input nodes (1, 2, . . . n) in a first column (of which only 3 are explicitly depicted) and an output node in a second column. Each input node receives a respective input, x₁, x₂, . . . xₙ which may, for example, be a real number in the range −1 to +1. Each input node has a respective connection (sometimes referred to as a synapse) with the output node, and each such connection has a respective weight, w₁, w₂, . . . wₙ (sometimes referred to as a synaptic weight). These weights are typically determined during the training phase using training data.

The output node forms a weighted sum of the signals received from the input nodes, namely Σwᵢ, xᵢ (summed over i). This weighted sum is then transformed using an output conditioning function (such as the S-shaped curve shown schematically in the bottom right of the left-hand portion of FIG. 1) to produce the output signal y from the output node. Note that if the weight values are limited to binary 0 and 1, then the above summation does not involve multiplication.

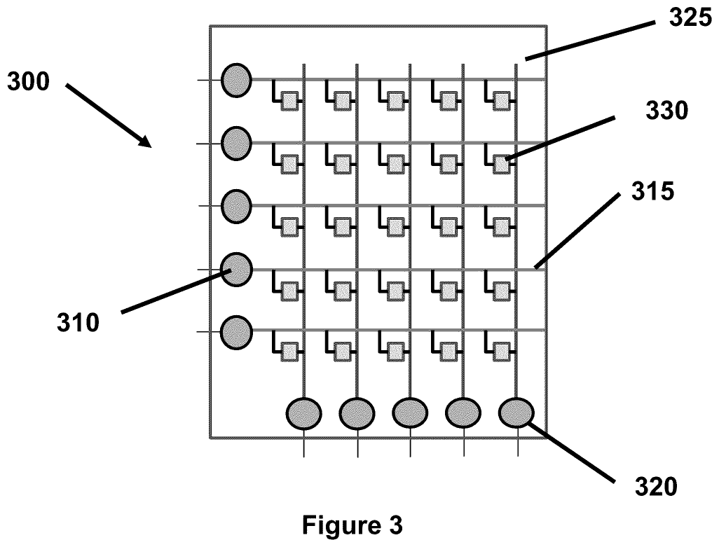

It will be appreciated that the left-hand portion of FIG. 1 is typically only a small portion of the overall network. For example, there may be one or more columns before and/or after those shown in FIG. 1, the network may comprise multiple layers, and so on. In addition, the number of output nodes may be greater than 1 as shown in FIG. 1. Each output node may be connected to each input node in the same manner as the single output node shown in FIG. 1. FIG. 3 (described below) provides an example of such a configuration, in which there are five input nodes and five output nodes, in which each of the former is connected to each of the latter (and vice versa). Accordingly, the left-hand portion of FIG. 1 is intended to serve as a simple example, and the skilled person is aware of many routine variations and/or extensions to this example.

The right-hand portion of FIG. 1 illustrates the same portion of a network as the left-hand portion of FIG. 1, but in this case the network is configured as a Bayesian (Probabilistic) Spiking Neural Network. In such a network, an input signal is no longer a single steady signal value (e.g. xᵢ) as per the DL network in the left-hand portion of FIG. 1, but rather a time sequence of spikes (e.g. xᵢ(t)) for each input node.

In the implementation of FIG. 1, the spikes are of uniform intensity producing a binary input signal (0 or 1). Note however that the present approach is not limited to the use of binary spikes and might be adopted in other types of network, for example a network in which each spike has an amplitude (signal height) taken from a continuous distribution, for example, a real value between 0 and 1.

The time axis in the SNN can be considered as comprising a set of discrete time intervals, whereby each time interval does, or does not, contain a spike. In the example shown in FIG. 1, the spikes are relatively sparse, in other words, for a given input, a spike is only present in a relatively small proportion of the time intervals (such as <15%, <10%, <5%, <2%, <1%, <0.5%, <0.2%, <0.1%).

There are various ways in which the time series of spikes can be generated for a given input. For example, assuming that we have an input which is a real number x in the range 0 to 1 (analogous to the real numbers x₁, x₂, . . . xₙ typically used in the DL network shown in the left-hand portion of FIG. 1). Such a value may be represented by a series of spikes such that the interval d between each spike is given by d=k1 (1−x)+x·k2. in which k1 and k2 are constants, for example k1=10 and k2=30. In such an example, d scales linearly with x from d=10 for x=0 to d=30 for x=1 and the mapping from x to the output time sequence, x(t) is deterministic, in the sense that input value of x can be determined directly from the observed time sequence of spikes x(t). In other implementations, the mapping might be probabilistic. For example, x(t) might be formed, for each discrete time interval, by using the input value of x to sample from a probability distribution—such as a Poisson distribution with mean (x/10). In some other cases, the time sequence input x(t) may be directly created from a time sequence input, such as photon detection, goals in a football/soccer game, and so on (rather than being mapped from a single real value). Accordingly, the approaches described herein for generating x(t) from a value x are provided by way of example only, and many other approaches will be apparent to the skilled person.

The general operation of the SNN is broadly analogous to that of the DL network in the left-hand portion of FIG. 1. Each input node (first column) has a corresponding connection to the output node (second column), each connection being associated with a respective weight, w₁, w₂, . . . wₙ. The output node performs a weighted sum, in which the current through the synaptic weight due to each spike input is added to a membrane potential (as described below) for that node, and the results are summed across all connections, i.e. across all input nodes. Note that since the spikes are binary values, the weighted sum can be determined solely by addition, without multiplication.

However, there are also some differences between the operation of the SNN shown in the right-hand portion of FIG. 1 compared with the operation of the DL network in the left-hand portion of FIG. 1. For example, there are various ways in which the input spike streams (x₁(t) etc) may be processed. In the most basic model, each time interval is treated independently and the signal is taken to be 1 if this time interval contains a spike, and 0 if it does not, and these values are then used directly to create the weighted sum for each time interval. However, it may be desired to perform some form of low pass filtering (LPF) on the input (especially if the spike sequences are sparse). This type of filtering has various names/implementations—a moving window, top hat filtering, (leaky) bucket filtering, or finite impulse response (FIR) filtering. LPF typically involves forming a sum from the last N time intervals (wherein increasing N in effect lowers the pass frequency). In some cases, the sum may be weighted, whereby the most recent values typically receive the highest weighting, whereas the oldest values receive the lowest weighting (this is sometimes referred to as leaky bucket filtering).

After the inputs x₁(t) etc have been low pass filtered (or directly, if there is no LPF), the signals from the input nodes are combined using a weighted sum as described above for the left-hand portion of FIG. 1. However, whereas in the DL network each weight (w₁, w₂, . . . wₙ) is defined as a single (fixed) value, this is no longer the case for the SNN on the right-hand side of FIG. 1. Instead, each connection has an associated probability distribution for the weight. Such a distribution may be discrete or continuous according to the circumstances of any given implementation. In the case of binary weights, 0 and 1, the weight distribution would be a binomial distribution in which p is the probability of having a 1, and for n samples the mean is np and standard deviation √[np(1−p)]. If the weight is not restricted to binary values, then in some cases a given weight might follow a Gaussian distribution having a particular mean and standard deviation. These probability distributions for the weights (or at least the parameters thereof) are determined during the training phase to form part of the model. For example, the probability distributions can be treated as Bayesian priors which are updated to create a posterior in response to observations of the training data.

Subsequently, during inference, when a weighted sum is to be calculated, a sample of each weight may be taken from the respective weight distributions. In this approach, the output from the SNN is probabilistic (rather than deterministic) because the inference output will vary according to the particular sample weights used for performing the inference. As described in more detail below, this variation in output allows a confidence interval to be associated with the inference results.

The output signal y(t) is also a time series of spikes, like the input. An example of generating this output is for each discrete time interval to calculate the weighted sum as above, and then determine whether or not to output a spike based on this weighted sum. Such a determination may be made in a deterministic or probabilistic manner. For example, in the former case, a spike may be produced if the weighted sum exceeds a threshold; in the latter case, the weighted sum may be used to control the probability of generating an output spike.

In some implementations, a membrane potential is maintained internally to each output node. The membrane potential increases when an input is received by the output node over a connection from an input node. The membrane potential may increase by the weight associated with the connection from the input node (or by an amount based on some function of this weight). The membrane potential decreases (e.g. resets) when the output node transmits an output spike to the next core or layer (as described in more detail below) or may reduce by some amount at every instant in time (referred to as leak).

The membrane potential can be used to control or regulate spiking output from the output node in a deterministic or probabilistic manner. For example, in some implementations, an output node might produce an output spike directly (deterministically) when the membrane potential exceeds some predetermined threshold. In other implementations, an output node might produce an output spike based on a probability distribution which is a function of the membrane potential. For example, having a higher membrane potential may increase the likelihood of the output node spiking during a given time interval. Alternatively, the membrane potential may be used as an input to a pass-band filter that implements resonate-and-fire neurons.

Note that there are various methods of implementing a weight within a synapse. One approach is to set the conductance to a fixed value in proportion to the value of a weight, whereby the synapse passes a current representing a desired fraction or percentage of the maximum current through the synapse. Another possibility, especially for a spiking neural network as described above, is for the synapse to implement the weight on a temporal basis. For example, a memristor may be switched between high and low resistance rates with a probability p that can be controlled in various ways, such as by the parameters of a programming pulse. Accordingly, if the synapse weight is 0.2, this would be implemented by a synapse which is programmed with a pulse that has an 80% chance of leaving the memristor in the low resistance state, and a 20% chance of leaving the memrister in the high resistance state.

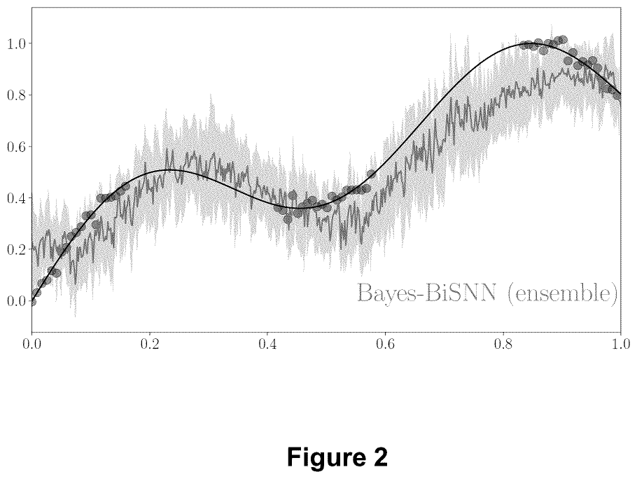

One example of the results from using a Bayesian (probabilistic) SNN such as described above is shown in FIG. 2. This is a standard 1D regression task, where the training data includes three separated clusters of input data points-scatter points in purple represent training data, while the full line in black represents test data. The shaded area represents the standard deviation for the predictions using the approach described herein when the weights are randomly selected from the variational posterior. By determining such a standard deviation, a user is able to assess the confidence level and uncertainty of the output from the SNN.

FIG. 3 is a schematic diagram of part of a crossbar array which may be used to implement an SNN according to the present disclosure. Thus FIG. 3 depicts one core 300 of the crossbar array. The core has 5 input nodes 310 shown as a column on the left side of the device, and 5 output nodes 320, shown as a row at the bottom of the device. There is an input line 315 respectively associated with each input node 310 and running across the device in the row direction. There is an output line 320 respectively associated with each output node 325 and running down the device in the column direction. Although the input lines 315 and the output lines 325 are shown as intersecting one another in a grid pattern, these intersections do not represent direct electrical connections. Rather, at each intersection a separate synapse 330 is located. A conductive path goes from each input line 315, through synapse 330, and then out to a corresponding output line 325.

FIG. 3 shows five input nodes 310, five input lines 315, five output nodes 320, and five output lines 325 (although of course other configurations may have different numbers of input and output nodes). There are 25 intersections (5×5), each intersection including one input line 315 connected to a respective input node and one output line 325 connected to a respective output node 320. This configuration therefore has a single path from a given input node 310 to a given output node 320, this single path going through the synapse 330 corresponding to the given input node 310 and given output node 320. If the synapse is ‘ON’ then a conductive path exists between the given input node 310 and the given output node 320. If all the synapses are ‘ON’, then each of the 5 input nodes 310 is operationally connected to each of the 5 output nodes.

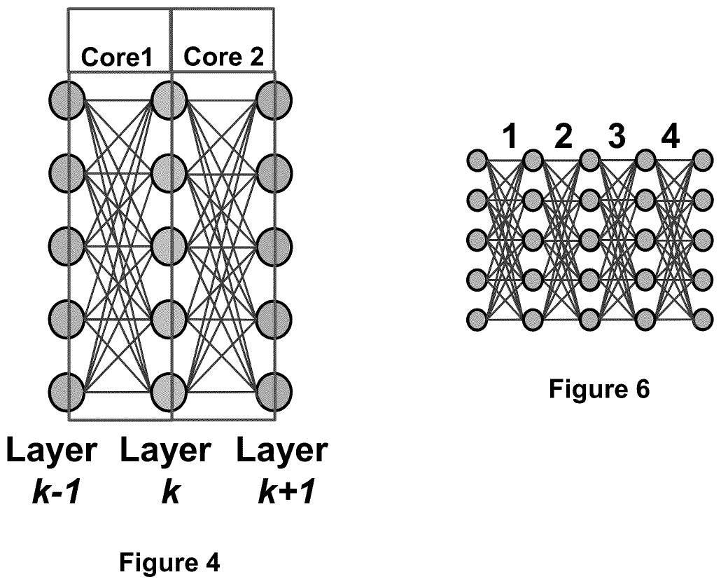

In some implementations, the network 300 may be part of a spiking neural network (SNN) as described above. In this case, each output node 320 is responsible for generating an output spiking signal (y(t)) to pass onto another core in the overall network (see FIG. 4 below), wherein the output spiking signal is dependent on the signals received by the output node 320 from respective input nodes 310. As previously discussed, this spiking signal may be generated in a deterministic or a probabilistic manner. Any low pass filtering as described above with reference to FIG. 1, such as a leaky bucket filter, may be implemented in the input nodes 310 and/or in the output nodes 320. For example, the input nodes 310 may receive a spiking signal from a previous core (not shown in FIG. 3) and perform the low pass filtering before forwarding the signal into the input lines 315.

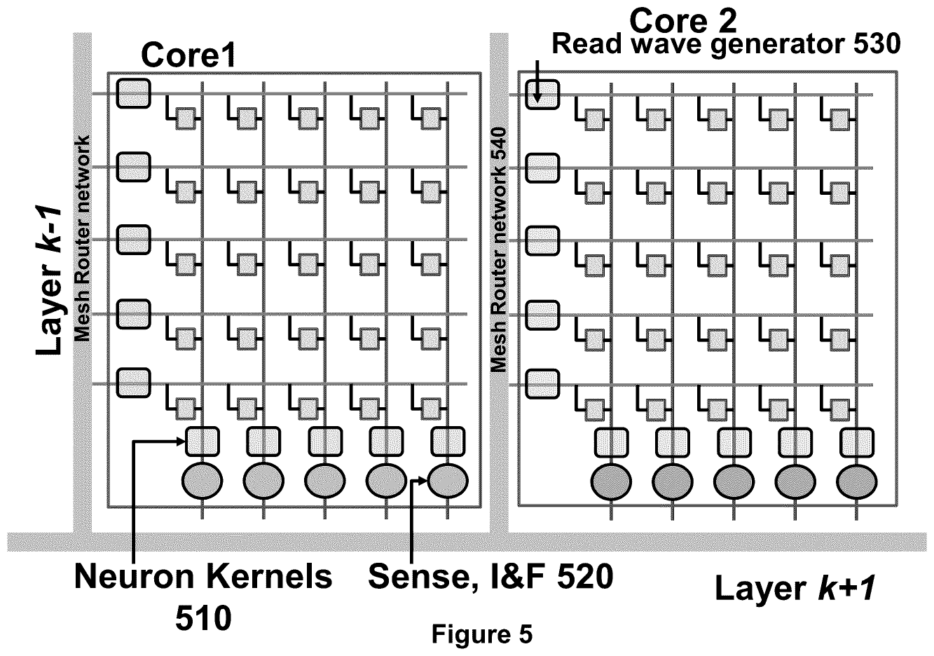

Alternatively, the input nodes 310 may not perform any low pass filtering, but pass on the input spikes directly to the output nodes 320, which then perform some form of low pass filtering prior to forming an output based a weighted sum of the inputs as described above. This model corresponds to the configuration shown in FIG. 5 (see below). A further possibility is that the low pass filtering may be split between the input nodes and output nodes, so that both input nodes and output nodes perform a portion of this filtering.

The synapses 330 in FIG. 3 can be used to implement (store) the weights in a neural network model. In particular, the lower the resistance (the higher the conductance) for a given synapse, the greater the current flow through that synapse-and in effect, the higher the weight associated with the given synapse. Therefore, for each output line 325, there are five synapses, each associated with a respective input line 315. The output line 325 receives current through each of these fives synapses in accordance with the respective conductance level for each synapse, and these currents are then aggregated to provide the output node 320 with a weighted sum (as discussed above in relation to FIG. 1).

In summary, the network core of FIG. 3 shows a grid (cross-bar) of five input nodes 310 and five output nodes 320. The synapses 330, one for each intersection, selectively determine the weight for signal flow from any given input node 310 to any given output node 320. Accordingly, each output node 320 receives a signal corresponding to the weighted sum (across all input nodes 310), the weights corresponding to, and implemented by, the conductance (or other appropriate physical property) of the respective synapse 330 associated with that input node 310 and that output node 320. In some cases, the weights may be constrained to binary values (0=low, 1=high), whereby the weighted sum can be implemented with addition only, without multiplication.

In one implementation of a neural network, such as shown in FIG. 3, each synapse comprises a corresponding memristor. A memristor is a two-input device in which the resistance (the relationship between applied voltage and resulting current) exhibits hysteresis-i.e. the resistance is dependent not just on the presently applied voltage, but also on the history of the applied voltage. Memristors have various advantages for use in neural network systems, including good compatibility with existing CMOS fabrication processes, and low power consumption, including memory of state without power, i.e. a memristor is non-volatile.

FIG. 4 is a schematic diagram showing multiple layers forming part of a crossbar array which may be used to implement an SNN according to the present disclosure. In particular, there are three layers shown, denoted k−1, k and k+1 (which may be just a small portion of a much larger number of layers). In the same manner as the core of FIG. 3, FIG. 4 shows a 5×5 configuration (five input nodes each connected to each of 5 output nodes), but it will be appreciated that this is just by way of example and many other configurations are possible. Note that in this context, the layers represent different logical layers in the configuration of nodes within the overall neural network (rather than different physical layers within the device).

The core 300 of FIG. 3 can be considered as corresponding to the left-hand portion of FIG. 4, whereby input nodes 310 are in layer k−1 and output nodes 320 are in layer k. The network of connections between layer k−1 and layer k in FIG. 4 therefore corresponds to the configuration of input lines 315 and output lines 325 shown in FIG. 3.

The right-hand portion of FIG. 4 shows a second core incorporating layers k and k+1, which may have the same configuration of nodes and connections as the first core 300 incorporating layers k−1 and k as shown in FIG. 3. Thus as shown in FIG. 4, the layer k of nodes forms both the output nodes of the first core and the input nodes of the second core (thereby supporting signal propagation through the layers of the neural network). In practice, the output nodes of the first core may be physically separate from (but directly connected to) the input nodes of the second core.

FIG. 5 is a schematic diagram showing further implementation details of the multiple layers (k−1, k, k+1) and first and second cores shown in FIG. 4. In particular, FIG. 5 shows the two cores of FIG. 4 each implemented using the crossbar array structure shown in FIG. 3. Thus in FIG. 5, each core has a column of input nodes shown on the left-hand side of the core. The input nodes for the first core comprise layer k−1, the input nodes for the second core comprise layer k. In addition, each core in FIG. 5 has a row of output nodes depicted across the bottom of the core. FIG. 5 further shows schematically a mesh router network 540 which provides interconnectivity between the different cores. For example, the mesh router network is used to send signals from the output nodes of the first core to the input nodes of the second core. Likewise, the mesh router network 540 is used to send signals from the output nodes of the core (not shown) between layers k−2 and k−1 to the input nodes (layer k−1) of the first core, and to send signals from the output nodes (layer k+1) of the second core to the input nodes of the core (not shown) between layers k+1 and k+2—and so on, for additional layers within the overall network.

FIG. 5 also provides an indication of further functionality within the input and output nodes. In particular, each output node includes a Sense, Integrate and Forward function 520, whereby each output node senses the signal on output line 325, which is the aggregate of the signal on each input line, each signal being multiplied (or otherwise modified) in accordance with the weight associated with the synapse 330 between the input node 310 for that input line 315 and the output node 320 for that output line 325. The integration functionality generally provides a form of low pass filtering, such as a top hat or leaky bucket filtering as described above, which samples and sums (optionally with weights) the signal sensed by that output node across an extended period of time-i.e. across a time period which is significantly longer than the duration of an individual spike. The output nodes 320 then forward the sensed and integrated signals onto the input nodes of the next core.

As shown in FIG. 5, each output node also includes a neuron kernel 510. This can be regarded as the control centre of the neuron to run various programs to implement the low-level functionality of the neural network. FIG. 5 also shows that each input node includes a read wave generator 530 which responds to an input signal (spike) from the corresponding output node of the previous core by instructing a read operation to be performed by the output nodes 320 of this core. Note that input signal provided by the output node of the previous core to the read wave generator 530 may be in various forms. For example, in FIG. 5 this input received from the output node of the previous core may be a spike sequence (deterministic or probabilistic). In other implementations, the input signal provided by the output node of the previous core may just be a fixed level signal resulting from the sense and integrate (and forward) operation 520 of the preceding output node. In some cases, the output node may incorporate some form of signal conditioning (analogous to the S-shaped curve in the left-hand portion of FIG. 1).

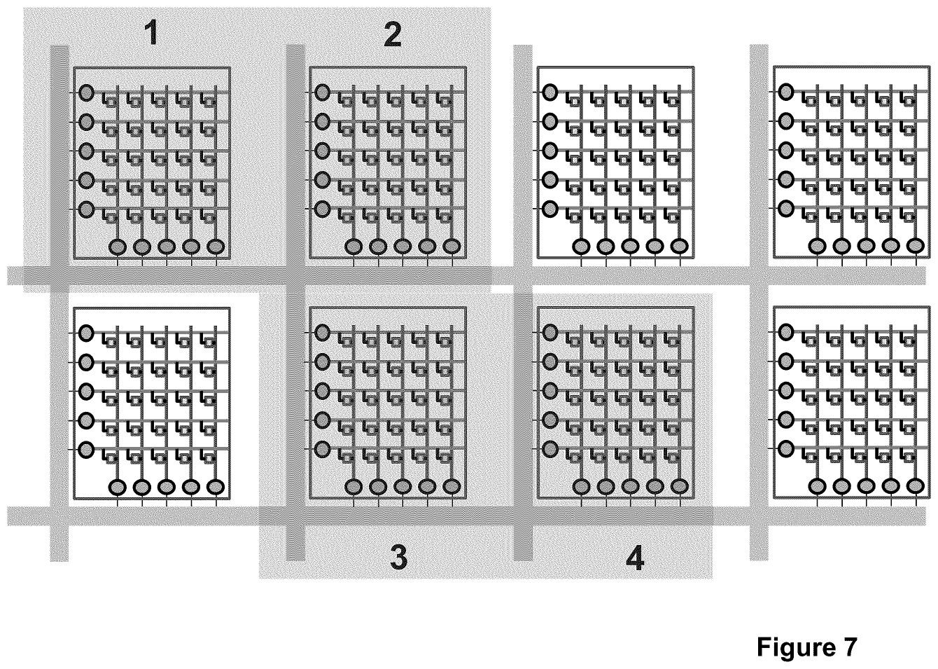

FIG. 6 is another schematic diagram showing multiple layers forming part of a crossbar array which may be used to implement a neural network according to the present disclosure. FIG. 6 is directly analogous to FIG. 4, but has been extended to five layers and four cores (labelled 1 to 4).

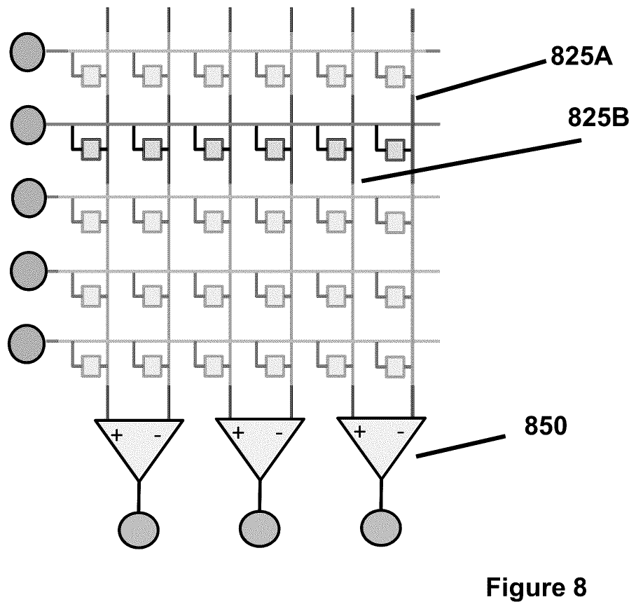

FIG. 7 shows an example of the physical layout of the five layers and four cores of FIG. 6. The internal arrangement of each core 300 corresponds to that illustrated in FIG. 3, with five input nodes on the left hand side of the core and five output nodes along the bottom of the core. FIG. 7 shows in particular the physical layout of cores 1, 2, 3 and 4 in terms of an on-chip spatial arrangement. It can be seen that a sequence of cores (and associated layers) forms a zig-zag pattern extending from top left towards bottom right according to an incremental path of one across (right), one down, one across (right) and so on, whereby this path can be extended (beyond that shown in FIG. 6) across the overall arrangement of layers and cores. Note that for the internal core layout shown in FIG. 3, connecting the output nodes 320 belonging to a first core to a set of input notes belonging to second core which is below or to the right of the first core involves relatively short physical connections, whereas if the second core is placed above or to the left of first core, the physical connections would be relatively short. Accordingly, the configuration shown in FIG. 7 utilises the relatively shorter physical connections thereby supporting faster and lower power operation.

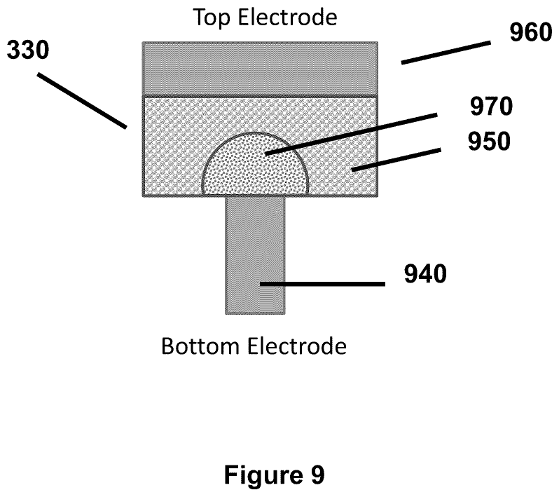

FIG. 8 is a schematic diagram of part of a crossbar array which is a variation on that shown in FIG. 3. In the configuration of FIG. 8, each output node is associated with two corresponding output lines 825A, 825B, which are connected to an output node via an adder 850 with one input negated. Therefore, output line 825A can be referred to as positive and output line 825B can be referred to as negative because they are respectively connected to the positive and negated input terminals of adder 850.

The configuration of FIG. 8 supports the use of negative weights. In particular, the conductance of a synapse is generally zero or a positive number which can be scaled to the range 0-1. By using a pair of corresponding output lines, 825A and 825B, each lying in the range 0-1, and then subtracting one from the other using adder 850 with one input negated, the resulting output signal will lie in the range −1 to +1. Although the implementation of FIG. 8 shows a core having 5 input nodes and 3 output nodes, it will be appreciated that the same arrangement of paired positive and negative output lines can be adopted in cores with different numbers of input and output nodes as appropriate for any desired configuration.

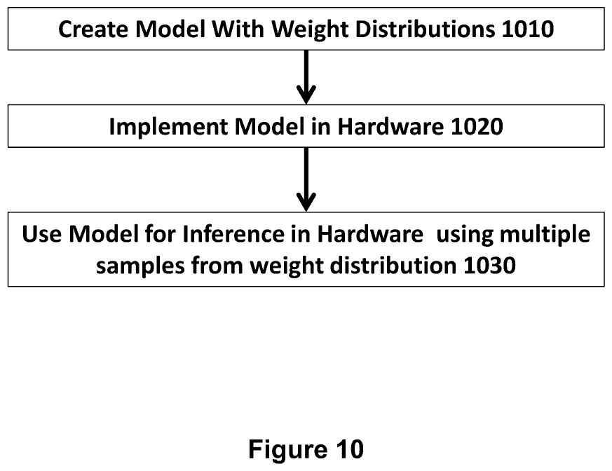

FIG. 9 is a schematic diagram of a memristor 330 based on phase change materials which may be used in a hardware implementation of the neural network such as shown in FIGS. 3-8. The memristor includes a bottom contact 940 and a top contact 960 which typically connect to an input line 315 of a synapse and to an output line 325 of the synapse respectively. The central portion of the memristor 330 between the bottom contact 940 and top contact 960 comprises an active poly-crystalline region 950 and an amorphous region 970 of the material Ge₂Sb₂Te₅ or its alloys (see for example: “Intrinsic memristance mechanism of crystalline stoichiometric Ge2Sb2Te5”, Li et al, Applied Physics Letters, 2013).

It will be appreciated a wide range of devices are known in the literature to exhibit memristor behaviour, for example (without limitation) resistive RAM, phase change memory, conductive bridge RAM, spin torque transfer, and the approach described herein could be implemented with any suitable device. The memristor forms a synapse which implements a weight of the neural network by controlling electrical conductance to modify the strength of signal propagation over a link between two nodes of the network. Other types of device have been suggested in the art for forming a synapse, including the use of capacitance or optical transmissivity to control signal propagation and thereby implement a desired model weight. It will be understood that the approach described herein is not limited to any particular form of synapse, but rather may utilise any suitable electronic or optical device which is able to control signal propagation to implement a desired model weight.

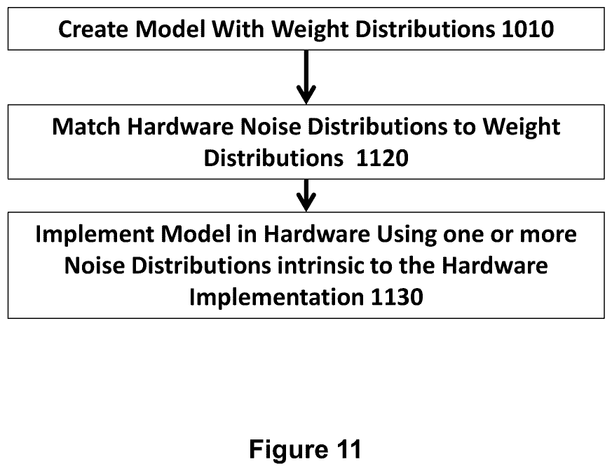

FIG. 10 is a flowchart of an example method for creating and using a hardware implementation of a neural network such as shown in FIGS. 3-9 according to the present disclosure. In an initial operation 1010, a neural network model is created. The model can be any standard form of neural network model except the weights for connections between nodes are specified in terms of a probabilistic weight distribution rather than a single fixed weight. Accordingly, when the model is run, the weight applied to a given connection between two nodes is not fixed in a deterministic manner, but rather will vary in a probabilistic manner according to the relevant weight distribution for different implementations and/or executions of the model.

The creation of the model in operation 1010 includes training the model using suitable training data to determine the model parameters, in particular the weight distributions. At this stage, the neural network can be considered as a model or logical structure. The model may be created in operation 1010 on a standard computer or any other suitable development computational platform. It is also possible, as described in more detail below, to create the model directly on the hardware system that is intended for productive use (inference).

In operation 1020, the model is implemented in hardware. Note that this hardware implementation does not represent a software implementation of the model running on a generic computer, but rather the hardware implementation reflects or mirrors the logical structure of the model. Thus as discussed above with reference to the neural networks shown in FIGS. 3-9, the hardware implementation generally contains physical components or structure directly representing and corresponding to the nodes, connections and synapses of the model.

With particular regard to the synapses, each synapse is implemented by a corresponding electronic, electrical or optical hardware structure having a physical parameter that determines the level of signal propagation through the synapse, and hence the level of signal propagation between the two nodes which are connected via the synapse. It will be appreciated that this physical parameter, and the resulting level of signal propagation through the synapse, corresponds to the weight to which the synapse has been set.

In operation 1030, the hardware-implemented model is now run (executed) to perform an inference operation (in effect, this represents production use of the hardware-implemented model). As noted above, in the neural network model described herein, the weights for respective synapses are not single fixed weights, but rather are specified as a distribution of weights. Accordingly, rather than running the model once with single fixed weights, the neural network model is run using multiple samples from the weight distribution. One motivation for this sampling of a weight distribution is for the model to produce a range of outputs, with different outputs deriving from and hence representing different weight values applied to the synapses of the models. This range of outputs provides an indication of the accuracy or robustness of the overall output. Typically the same weight distribution may be applied to all synapses which therefore have the same form, for example, binomial or a Gaussian distribution, but with some variations in the weight parameters as a result of training. In an example implementation, a neural network might be used to confirm that an individual presenting a passport is the person that the passport was issued to by comparing a picture of the individual (e.g. acquired at an airport) with a stored picture of the true passport holder. A conventional neural network with fixed weights might produce an output value (say in the range 0 to 1), whereby any outcome above a particular threshold (say 0.8) might be accepted as a match-i.e. in this case, the individual being pictured at the airport is accepted as being the same person as pictured in the passport.

However, if we obtain outputs corresponding to different samples from the distributions of synapse weights, as per operation 1030, this will produce a corresponding distribution of outcomes which may, for example, be characterised by a mean (μ) and a standard deviation (σ). Whereas the above threshold test for using fixed weights can be written as s>T, where s is the sample value and T is the threshold (0.8 for this example), in contrast, the threshold test with respect to samples representing a distribution of weights might typically be expressed as (μ-T)/σ>k where k is set according to the desired probability threshold of the result, analogous to standard confidence testing. For example, k might be set to a value of 3 or 4 or 5, where the higher the value of k, the greater the statistical likelihood that the individual being pictured at the airport is the same as the person whose picture is in the passport. Accordingly, obtaining different samples from across the distributions of synapse weights provides additional statistical information (μ and σ) which gives a more sophisticated (nuanced) understanding of the result or decision from the neural network, and hence greater confidence in the final outcome.

In order to apply the synapse weight distributions, multiple replications (trials) are performed, wherein different replications use different samples for the synapse weights. The different samples of the synapse weights adhere to the weight distribution function for each given synapse. For example, with binary weights and p=0.25, one quarter of the samples would have value 1 and the remaining three quarters would have value 0.

There are two different dimensions available for obtaining multiple replications, namely the temporal dimension and the spatial dimension. In the former case, which can be regarded as a series approach, there might be a single hardware-implemented set of nodes for the network, and the neural network is executed multiple times in succession on this set of nodes. Each execution of the neural network involves applying signals corresponding to the inputs and propagating the outputs of neurons through the synapses by reading their effective conductance or transmittance. The read noise associated with the device matches the desired distribution of the weights obtained after software training based on the learning algorithm. Accordingly, by using multiple successive executions in time, a desired number of replications may be performed.

Alternatively, in the latter case, which can be regarded as a parallel approach, multiple hardware implementations of the neural network are implemented in a given device or system. For example, the software determined weight values may be transferred into a set of memristive device arrays (such as shown in FIGS. 3 to 9) probabilistically by stochastic programming so that the conductance values of the devices in the different arrays closely match the distribution of weight values obtained after software training based on the learning algorithm. In such implementations, the forward propagation operation may be conducted concurrently in all the arrays, so that a distribution of output values is obtained, and this distribution is then post-processed to obtain a confidence metric for the decision.

By way of example, the core 300 such as shown in FIG. 3 may therefore be physically created multiple times, each time using a different set of weight values as sampled from the relevant weight distribution for each synapse. Accordingly, by using multiple executions performed in parallel across different hardware implementations, a desired number of replications may be performed.

Note that the hardware replication may be performed at the device and/or component level (the former is analogous to increasing computing power by obtaining additional computers, the latter is analogous to increasing computing power by adding extra processing cards into an existing computer). In addition, spatial and temporal replication may both be used in conjunction with one another. For example, in a given device, the hardware may be replicated to provide four parallel hardware implementations of a neural network model (each with a different set of sample weight values), and then multiple executions are performed in series on these four hardware implementations (each execution again using a different set of sample weight values) to increase further the total number of replications. It will be appreciated that the balance between temporal and spatial replications for any given system will depend on the particular circumstances of the system, for example, regarding issues such as device complexity and cost, speed of operation, power consumption, flexibility (in terms of number of replications) and so on.

Irrespective of the details of how the replications are performed (in parallel and/or in series), the results from the different replications allow characterisation of the variability of model output as the different sample weight values are applied to the synapses. This provides an insight into the sensitivity of the model output to variations in the model weights, thereby leading to a statistical (probabilistic) understanding of the model output and the confidence therein.

Although providing a hardware implementation of a neural network as described herein has many potential advantages compared with a software implementation of generic hardware, such as faster operation with less power usage, there are also some potential disadvantages. For example, there might be slight variations between a first component compared to a second (nominally identical) component due to slight differences in fabrication. Furthermore, hardware components (structures) are subject to a certain degree of noise or natural variation in their operation. This noise tends to increase as devices become smaller, and in some cases, this has acted as a disincentive or drawback for hardware implementations of neural networks.

In practice, the noise from a hardware implementation of a neural network is primarily experienced in two main contexts-(i) programming noise when the state of the memristor is set (akin to writing data into the hardware), and (ii) read noise, when the state of the memristor is read out. Typically, the read noise is more difficult to control than the programming noise. Thus a programming operation is usually used less often than a read operation, since data may be written once, and then read many times. Accordingly, it is easier to extend the timing of a programming operation to reduce noise, compared with doing so for a read operation, because the former has less impact on the overall performance of the device. Accordingly, in some devices it may be feasible to reduce programming noise by adopting an iterative procedure for a write operation (and/or by exploiting the wider range of control parameters, such as applied voltage, timing and pulse shape, that are available for a write operation).

The results obtained by a neural network are therefore generally subject to two influences, namely programming noise and read noise, however, the manifestation of these two noise sources depends on the configuration and operation of the hardware device. Thus in a series configuration, there is a single initial programming operation followed by multiple read operations. In this situation, the stored value typically has an offset due to the initial programming noise, but the subsequent read noise can be at least partly averaged out across the multiple read operations. In a parallel configuration, with a single programming operation followed by a single read operation across each device, the outputs from the difference devices experience the combination of both programming noise and read noise, but both of these noise signals are at least partly averaged out across different devices. In a hybrid configuration, with multiple reads across multiple devices, the succession of read operations for each respective device may first be averaged out to produce a value which reflects the programming noise (offset) for that device. The programming noise offsets for each device can then be averaged out across the set of devices. Accordingly, in addition to the considerations set out above, the selection of configuration for the hardware devices (series, parallel or hybrid) may be subject to additional factors, such as the (typical) relative size of the programming noise and the read noise, the potential ability to reduce the programming noise by particular control measures, and so on.

It will be apparent from the above discussion that the hardware noise will contribute to the overall variability (standard deviation) of the results, in addition to the variation arising from the sampling of the weights according to the weight distribution. For example, consider an implementation in which a computing device is used to create successive versions of the neural network, each version having a different sampling of weights, and each version being downloaded (in series or in parallel) onto a hardware device such as shown in FIG. 3 and run to produce an output. The overall variability of the outcome, i.e. the distribution of outputs, has a first component from the versions sampling different weights, and a second component from hardware (programming and read noise). We note that the first component is of particular interest for assessing the behaviour of the neural network model per se (i.e. without hardware effects such as noise), and it is possible to derive useful information about the first component. Firstly, the overall variation in the output represents an upper limit to the first component (in the case that the noise of the second component is zero). Secondly, it may be possible to estimate the hardware noise level, for example by separate measurements of various devices, and this estimate can then be used in effect to subtract the second component from the observed overall variation to estimate the variation of the first component. It is also noted that having multiple versions for sampling a weight distribution (rather than just a single weight) allows the hardware noise to reduce (at least partly average out) across the multiple versions.

However, as described herein, it is possible to take a significantly different approach, which utilises the hardware noise (rather than regarding it as a source of error or inaccuracy). In this approach, the weights are transferred from a traditional computing platform to the hardware platform using a probabilistic programming scheme which leverages the stochastic programming characteristics of nanoscale memristive devices. In other words, rather than having to explicitly set synapses in accordance with the distribution of weights, this can be achieved implicitly by using one or more sources of hardware noise to represent the distribution of weights. This approach helps to reduce the overall level of uncertainty, because the variation in results arising from sampling of the weight distribution is no longer superimposed onto the noisy device operation, but rather the noise of the device operation is configured to itself reflect the variation in results arising from sampling the weight distribution.

We note that those working on memristors and similar devices have generally regarded noise as detrimental—something to be reduced to as low a level as possible. In contrast, the present approach is able to utilise the hardware noise in a positive function, which is very different to most current implementations. Note also that this is achieved without having to implement any form of conventional random number generator (RNG) in the nanoscale memristive device (which would add significantly to the complexity and expense of such a device).

Accordingly, as described herein, it is feasible to exploit the hardware noise to model the weight distributions. As described above, the hardware noise typically manifests itself when performing two different types of operation—namely (i) a programming (write) operation to set the weight for a synapse, and (ii) a read operation in which a signal propagates through the synapse to arrive at the relevant output node.

As an example of this approach, Spin-Transfer Torque Random Access Memory (STTRAM) devices can be programmed to low or high resistance states in a probabilistic manner, whereby the probability of attaining a 0→1 and 1→0 transition can be controlled by varying the pulse width or pulse amplitude of the programming pulse. Similarly, resistive random access memory (RRAM) devices also exhibit probabilistic switching between high and low resistance states which can be controlled by tuning the shape of the programming pulse. Such devices can then be used directly to simulate a binary distribution of weights.

Another possibility is to design a synapse to control the operational noise associated with the synapse. For example, a simple implementation of the synapse might have a single component (such as shown in FIG. 9) in series between the input and output lines. However, a more complex arrangement for a synapse may involve two components in parallel with one another. The two components may be adjusted to have different weights and/or different noise levels as appropriate (the latter might be achieved by changing one or more parameters of the two components with respect to one another). The weights of the two components can be selected as appropriate to achieve the desired overall weight for the synapse (to match the specified sampled weight distribution). The noise levels of the two components can be selected to achieve a desired overall noise level (which also matches the distribution of weights). More complex arrangements of synapse components in series and/or parallel can also be utilised to further control the noise level.

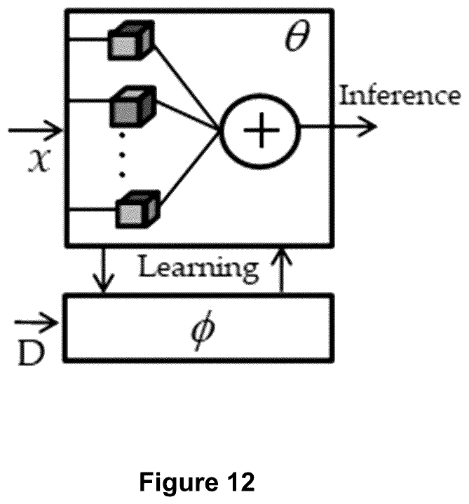

FIG. 11 is a flowchart of an example method for creating and using a hardware implementation of a neural network in which the distribution of weights is implemented using one or more noise processes in the hardware according to the present disclosure. In operation 1010, which is the same as operation 1010 in FIG. 10, the model is created (including training) and appropriate weight distributions are determined.

In operation 1120, an analysis is performed to map the weight distributions to noise within the hardware implementation. There are various ways in which this may be achieved, dependent (inter alia) on the nature of the weight function to implement-e.g. a binomial distribution or a Gaussian distribution (or a combination of two or more such distributions). In addition, the approach adopted may vary with the particular type of hardware device selected to implement the synapse memristor.

Among the options using hardware noise for matching the weight distributions specified in the neural network model are:
(i) using different parameters to program a memristor
(ii) using different parameters to read a memristor
(iii) selecting different circuit arrangements of one or more memristors to form a given synapse
(iv) selecting whether to perform multiple executions in series on a single device, or in parallel across multiple different devices
(v) any combination of the above.

In operation 1130, the model weight distributions are implemented in hardware using one or more noise distributions intrinsic to the hardware implementation. Note that although this operation is shown in FIG. 11 as following operation 1120, in some cases the two operations might overlap. As an example of the processing of the flowchart of FIG. 11, a binary read operation might be susceptible to noise which varies in dependence on the read voltage used. Accordingly, the value obtained in this read operation might have a probability of p for an output of 1 and (1−p) for an output of zero, where the value of p is dependent on the read voltage. If the model includes a binary weight distribution with probability p′, operation 1130 may adjust the read voltage such that p=p′. Accordingly, sampling a weight distribution may involve no more than repeatedly reading a synapse (or other component), since the latter distribution now matches the former desired weight distribution. This therefore represents a particularly efficient implementation because the weight distribution is obtained directly from the read hardware, without needing any additional components or operations specifically to implement the desired weight distribution.

In the description so far, it has mainly been discussed how the neural network is created on a standard computing platform and then implemented in the specialised hardware such as shown in FIGS. 3-9. However, it is also possible to create the neural network in this specialised hardware, as will now be discussed. Note that a neural network created in this manner may then run on the same specialised hardware device and/or be copied onto one or more other systems if so desired.

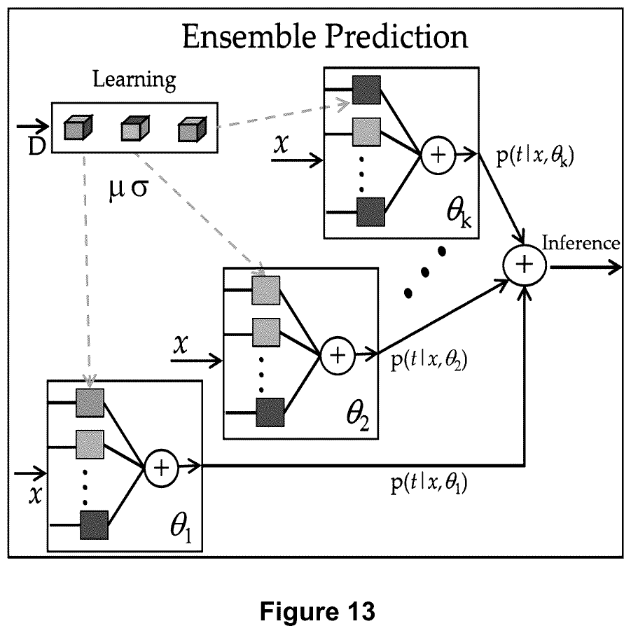

FIG. 12 is a high-level schematic diagram showing the training of a neural network and then the use of the trained neural network for performing inference. In FIG. 12, D refers to data that is available for optimising the neural network, φ represents the learnt parameters of the network such as the mean and variance of the weight distributions, and θ corresponds to an instantiation of the learnt distribution, including the particular samples of weight values for that instantiation. The parameters φ control the distribution of the weights θ. As described herein, in some cases the desired weight distributions are obtained in the neural network by combining the conductance variability statistics of multiple 2-terminal devices. Inference may be carried out by running the network for a fixed φ on the same input multiple times to collect statistics that quantify predictive uncertainty, e.g. by providing some form of confidence interval for the output. The weights θ may be randomly sampled using device variability (such as described above with reference to FIG. 11) for each run.

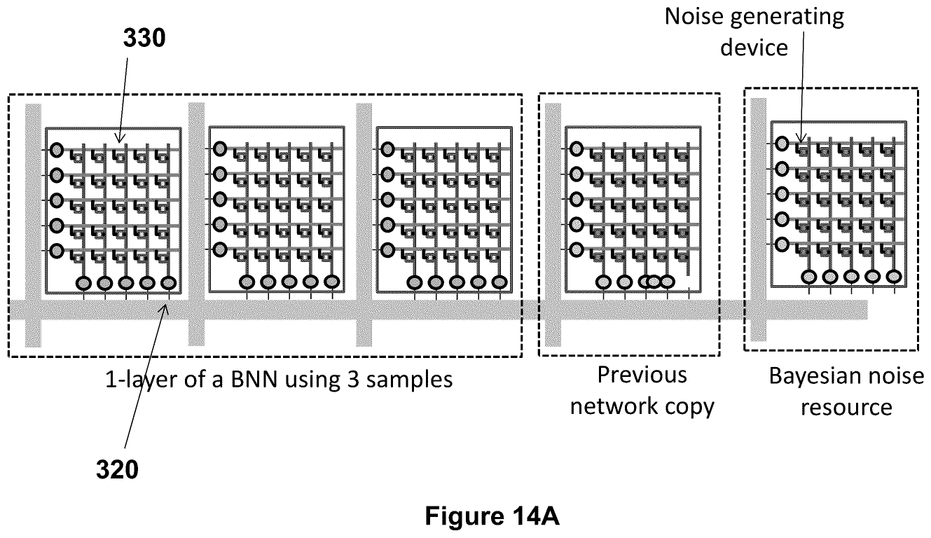

FIG. 13 is a schematic diagram showing in more detail the training and inference processes for an ensemble architecture containing multiple neural networks (each such neural network may be similar to that shown in FIG. 12). In FIG. 13, D again refers to data that is available for optimising the network, φ represents the learnt parameters of the network—say mean μ, and standard deviation φ for the weight distributions. In some cases, the desired distributions are obtained in the neural network hardware by combining the conductance variability statistics of multiple 2-terminal devices (such as memristors). Inference may be carried out by running the network for a fixed φ on the same input multiple times to collect statistics that quantify predictive uncertainty and hence may be used, for example, to set a confidence level (as discussed above). The weights for each instantiation may be sampled at random using device variability (at the level of hardware noise) for each run (execution) of the inference engine. In the example of FIG. 13, learning may involve updating the distribution parameters φ using a peripheral module which communicates with the crossbar array to provide the updated parameters φ and inference outcomes based on the data D. The weights, which may be used to determine conductance values for the hardware device, may be discrete or continuous. The trainable parameters φ generally represent the corresponding distributions and associated uncertainty obtained via inference. The activations of the neurons implemented by the crossbar can be binary or continuous, encompassing conventional neural networks and spiking neural networks.

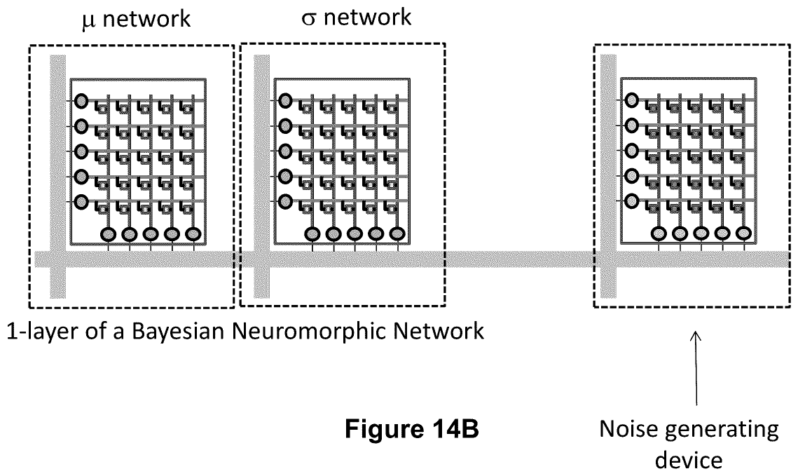

Although FIG. 13 shows a single device being used for both training and inference, it will be appreciated that this is not required, and that training and inference may be performed on different devices. For example, it has already been discussed that the training might be performed on a standard computational platform. Conversely, a model as trained using the apparatus of FIG. 13 (and potentially also using the apparatus of FIG. 14 described below) may be transferred to a different system for inference—for example, to a standard computational platform, and/or to another hardware device similar to that shown in FIGS. 13 and 14.

Note also that in some contexts, training may comprise two phases: firstly a generic training (suitable for all users) and secondly a user-specific training or customisation. By way of example, a speech recognition system may be formed in this way, with generic training that provides reasonable performance for all users, and user-specific training that provides enhanced performance for the specified user. The training shown in FIG. 13 may comprise the generic and/or specific phases of training. Note that the ability to train and perform inference in a single device has the advantage of allowing (at least) the second phase of training to be performed after deployment.

The learning block shown in FIG. 13 may determine the mean and standard deviation of each weight distribution. Each of the multiple blocks is a multi-layered spiking network which provides a fixed instantiation of this weight distribution, where the sampled weights taken as a whole across different blocks should match the mean and standard deviation obtained from learning. Note that the sampling of the weights for the different instantiations may be done off-line (rather than on the specific hardware shown in FIG. 13). The architecture of FIG. 13 can be considered as an ensemble, with each member of the ensemble corresponding to a different block and having a different realization (instantiation) of the weight values. It will be appreciated that with this architecture, there is a trade-off between space (number of blocks) and accuracy (the more blocks, the better the sampled weight values will match the desired weight distributions).

The architecture in FIG. 13 is based on the use of Gaussian distributions for the weights as specified by mean μ and standard deviation o as determined during the training. These parameters (mean μ and standard deviation σ) may be passed to each instantiation which then samples the distribution for each weight in the neural network to determine the specific model for each instantiation. The instantiations in FIG. 13 are labelled θ1, θ2, . . . θk, where θ1 represents the first model instantiation, including the sampled weight values for that particular instantiation (and likewise for θ2, etc). This is indicated schematically in FIG. 13, in which the different coloured squares may represent weights with different sample values (It will be appreciated that although the approach of FIG. 13 utilises weight distributions which are Gaussian in form, the architecture can support any suitable form of any weight distribution).

FIG. 13 further shows the architecture being used for inference, whereby φ, the set of samples from the weight distributions used in the set of instantiations (θ1, θ2. . . θk) for performing the inference, is fixed for inference (rather than being updated and optimised during training). In inference, each instantiation performs its own individual inference using the weight samples adopted for that instantiation. Furthermore, as discussed above, additional instantiations (executions) can be created in the temporal dimension (instead of or in addition to having multiple instantiations in the spatial dimension). For each new execution of the instantiations in the temporal dimension, the value of φ is fixed (the parameters of the weight distributions remain the same), however, the weight distributions are newly sampled to obtain a new set of sample weights for use in each new execution of a given instantiation.

The resulting set of inferences, one from each instantiation, can then be collated (combined) to produce an inference output. For example, if the inference output is a single value for each instantiation, then the overall inference output might be taken as the mean of these single values across the ensemble of instantiations. As described above, the spread or variation of the single values from the different instantiations can be used to determine a parameter such as the standard deviation of the single values, which allows a confidence range or similar to be provided for the results of the inference (which is not generally available for many other neural network implementations).

As discussed above, a typical nano-scale hardware implementation is subject to noise, especially read noise, which may then feed through to the inference performed on the basis of those weight distributions. As described herein, this noise may be utilised to represent weights having a Gaussian distribution (assuming that the noise also has such a Gaussian distribution).

FIGS. 14A and 14B (collectively referred to as FIG. 14) are schematic diagrams showing how the hardware system of FIGS. 3-9 can be used for training a neural network according to the present disclosure. Thus FIG. 14 shows portions of a crossbar array comprising multiple cores 300, each core including input nodes 310, output nodes 320, synapses 330, input lines 315 and output lines 325 as described above.

The three blocks on the left in FIG. 14A represent three samples of a neural network model in the process of being trained, whereby each sample has different (sampled) values from the weight distributions according to the current state of the neural network. At each training iteration, the block indicated as a Bayesian noise resource generates a sample of the distribution defined by the parameters μ and σ (typically a Gaussian distribution), see FIG. 14B. This sample is then used to provide a gradient estimate which determines a direction of modification for the distribution parameters μ and σ (to try and match the training data better) and the parameters μ and σ are updated accordingly. (Note that the gradient estimate and parameter updating may be performed by peripheral circuits of the hardware, not the cores themselves).

As shown in FIG. 14A, forward propagation is now performed using the updated parameters to decide if the update should be accepted or rejected, according to whether or not the updated parameters are found to improve alignment with the training data. If the updated parameters do improve alignment (reduce cost) the updated model parameters are accepted; however, if no such improvement is found, the update is rejected and we revert back to the previous state of the neural network.

In the implementation of this training (optimisation) procedure in FIG. 14, each core is updated one at a time, so during the update, a copy of this (single) core is retained in hardware, in case it is required to back out of the update, should the forward propagation find that performance would not be enhanced by the parameter update. In this case, the parameter update is not accepted and the core in question is returned to its previous state using the copy of the core stored in its previous state (see the second core from the right in FIG. 14A). We again note that this approach set out in FIG. 14 does not train the weights per se (as for a conventional neural network), but rather the weight distributions (see FIG. 1 right-hand portion) and the actual weights are then determined by sampling the weight distributions.

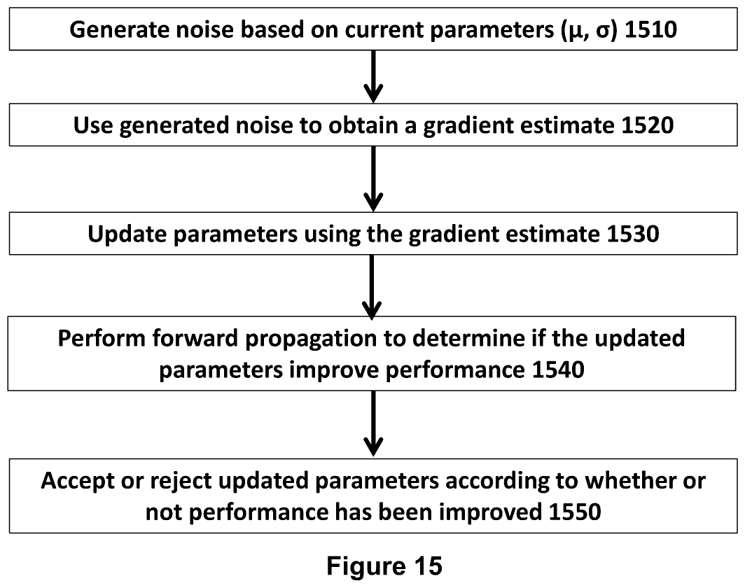

FIG. 15 is a flowchart of an example method for training a neural network model implemented in hardware such as shown in FIG. 14 according to the present disclosure. In particular, the flowchart corresponds to one iteration of training. At operation 1510, noise is generated according to the weight distribution parameters (mean u and standard deviation σ). As described in more detail below, this noise may be generated using physical noise which is intrinsic to the operation of such a nanoscale device as shown in FIG. 14. At operation 1520, the generated noise is utilised to determine a gradient estimate, and at operation 1530, the parameters are updated based on the gradient estimate. At operation 1540, forward propagation is performed to determine if the updated parameters improve performance, i.e. whether the alignment of the model to the training data is improved. If this is the case, then at operation 1550, the updated model parameters (mean μ and standard deviation σ) are retained, else if not, the updated model parameters are rejected. This in effect returns us to operation 1510 for the next iteration. Note that even if the model parameters have not been updated at operation 1550, the noise generated at operation 1520 is different each time, so this creates a new opportunity to update and improve the parameters. The processing (iterations) may terminate when the error (difference) between the model predictions and the training data is below a given threshold, or else when a maximum number of iterations has been reached.

As previously described, read and write operations using a nanoscale device such as shown in FIG. 14 are subject to noise which is generally Gaussian in nature. The approach described herein can utilise this noise to provide a noise generator such as shown in FIG. 14 which generates physical noise (rather than implementing some algorithmic random number generator, which is more difficult and power consuming in such a nanoscale device). The noise generated in this manner can be scaled to match the model parameters (mean u and standard deviation σ) of the present iteration. The hardware noise is intrinsic to the device and so cannot be eliminated; using it in this manner to implement the weight distributions (rather than using some separate source of variation) avoids the hardware noise acting as a form of perturbation on the weight distributions. For example, if an implementation involves one or more instantiations performing one or more successive executions, and the hardware noise is matched (scaled) to the parameters (μ, φ) of the weight distribution, then the hardware noise can be used directly for sampling successive weight values for use in each successive execution of an instantiation.

Note that the scaling from the hardware noise level to match the model parameters (mean μ and standard deviation σ) can be performed in the hardware itself by creating circuits of two or more components (such as transistors) in parallel and/or in series as desired. In this way, the hardware noise level can be scaled up or down compared to the hardware noise level associated with a single memristor (or other suitable device).

The approach described herein provides a number of potential advantages (according to the specifics of any given implementation):
* the use of weight distribution functions allows the decision engine during inference to provide not only a decision, but also a confidence metric associated with that decision.
*an architectural implementation based on spiking neural networks and binary weights is highly efficient in that forward propagation does not require multiplication operations (rather just addition)
*the multiple instantiations are used to express different weight samples and to provide the confidence metric
*the stochasticity and variability in the conductance characteristics of memristive devices is no longer a nuisance to be mitigated, but instead are transformed into a resource that are used to implement efficiently the Bayesian sampling of the weight distributions. Compared to existing methods for generating random numbers using deterministic CMOS transistor circuits, the hardware approach of the present approach uses less chip area and less power.
*in some implementations, the weights may be transferred to the hardware using a probabilistic programming scheme, leveraging the stochastic programming characteristics of nanoscale memristive devices. For example, it is well known in the art that Spin-Transfer Torque Random Access Memory (STTRAM) devices can be programmed to low or high resistance states in a probabilistic manner-the probability of attaining a 0—>1 and 1—>0 transition can be controlled by varying the pulse width or pulse amplitude of the programming pulse. Similarly, resistive random access memory (RRAM) devices also exhibit probabilistic switching between high and low resistance states which can be controlled by tuning the shape of the programming pulse. In such an approach, if the distribution of the probabilistic programming scheme matches the desired weight distribution, the latter can be implemented by repeatedly performing the same programming operation, and this will then result in a distribution of inputs (given the stochastic nature of the programming) that implements directly at a hardware level sampling from the desired weight distribution function.

Accordingly, the hardware architecture described herein enables efficient inference engines operating with low latency and low power budgets (compared for example to existing Si CMOS based technologies). Such hardware could be integrated into a wide range of devices and products, such as mobile computational and communication devices, IoT sensor networks, decision making agents in autonomous vehicles, and so on. The disclosed hardware architecture helps to support:
*emerging applications such as Big Data, mobile services, cloud services, and IoT (Internet of Things), which require abundant computing and memory resources to generate services and information for clients.
*neuromorphic computing (such as the spiking neural networks described herein), which is recognized as a promising tool for enabling high-performance computing and ultra-low power consumption to achieve these goals.
*edge computing which is gaining prominence owing to its features of localized computing, storage and processing capabilities which are critical to successful implementation of IoT devices. (Neuromorphic chips will further advance the capabilities of edge computing).

The present disclosure provides (inter alia) a hardware system or platform for decision making which comprises a physical device where a neural network whose parameters may be represented by a distribution of real valued numbers and are mapped onto the effective electrical conductance or some other electrically or optically measurable physical attribute of nanoscale devices configured at the intersection of crossbar arrays. The parameters of each layer may be represented by multiple devices in one or more crossbar arrays. The device conductance or some other electrically measurable attribute may be programmed to map the software-learnt distributions of numbers. The process of decision-making may involve combining the outputs of the hardware cross-bars measured several times consecutively or by combining the output of several such cross-bars such that the aggregate output represents not only a unique decision, but also a profile of decisions along with a quantifiable estimate in the confidence or uncertainty in each decision. The distribution of parameter values for the network may be obtained using learning algorithms that are applied on data that runs on a computing device.

The present disclosure further provides a hardware architecture or system design for on-hardware learning and decision making. The hardware architecture comprises a hardware platform where a neural network whose parameters may be represented by a distribution of real valued numbers and may be mapped into the effective electrical conductance or some other electrically or optically measurable physical attribute of nanoscale devices configured at the intersection of crossbar arrays. The parameters of each layer may be represented by multiple devices in one or more crossbar arrays, with the device conductance or some other electrically measurable attribute programmed to map the software-learnt distributions of numbers. The process of learning or training involves determining the distribution of parameter values for the network using the platform by passing data through the hardware and using special-purpose circuits implementing 3-factor learning rules or other suitable learning rules that are derived based on the principles of Bayesian inference.

The process of decision-making involves combining the outputs of the hardware cross-bars measured several times consecutively or by combining the output of several cross-bars such that the aggregate output represents not only a unique decision, but also a profile of decisions with a quantifiable estimate of the confidence or uncertainty in each decision.

In conclusion, while various implementations and examples have been described herein, they are provided by way of illustration, and many potential modifications will be apparent to the skilled person having regard to the specifics of any given implementation. Accordingly, the scope of the present case should be determined from the appended claims.

1. A hardware system including a neural network, the neural network comprising nodes interconnected by respective synapses implemented by respective hardware devices, the hardware system generating an output by performing an inference operation using the neural network;
wherein operation of the respective synapses is controlled by setting a physical property of the respective hardware devices implementing the respective synapses, at least one of setting the physical property or reading the physical property being subject to noise;
wherein the neural network associates probabilistic weight distributions with the respective synapses, wherein setting the physical property of a given hardware device implementing a given synapse comprises applying a weight value sampled from the probabilistic weight distributions corresponding to the given synapse;
wherein performing the inference operation comprises performing multiple inference determinations using multiple respective sampled weight values for the respective synapses to obtain multiple inference results, the multiple inference results indicating a confidence interval for the output of the inference operation.

2. The hardware system of claim 1, wherein the neural network is a spiking neural network.

3. The hardware system of claim 2, wherein the spiking neural network has binary or multi-valued spikes.

4. The hardware system of claim 1, wherein the neural network is Bayesian.

5. The hardware system of claim 1, wherein the multiple respective sampled weight values are binary.

6. The hardware system of preceding claim 1, wherein the probabilistic weight distributions are binomial, Gaussian, Weibull, log-normal, or any other long-tailed distribution.

7. The hardware system of claim 1, wherein the hardware system is configured as a crossbar array or a collection of crossbar arrays.

8. The hardware system of claim 7, wherein the crossbar array comprises multiple cores, wherein each core of the multiple cores comprises a set of input nodes connected to a set of output nodes such that each input node of the set of input nodes has a separate connection to each output node of the set of output nodes via a synapse.

9. The hardware system of claim 1, wherein each respective hardware device for each respective synapse comprises a memristor.

10. (canceled)

11. The hardware system of claim 1, wherein the physical property comprises conductance, capacitance or optical transmissivity.

12. The hardware system of claim 1, wherein performing multiple inference determinations comprises:
successively performing multiple inference determinations with different sampled weight values for the respective synapses on a same hardware device of the respective hardware devices: or
performing multiple inference determinations with different sampled weight values for the respective synapses on multiple hardware devices of the respective hardware devices.

13. (canceled)

14. The hardware system of claim 1, wherein the probabilistic weight distribution is mapped onto the noise associated with the physical property, such that reading the physical property inherently provides a sample weight value of the probabilistic weight distribution.

15. The hardware system of claim 14, wherein each synapse of the respective synapses is formed from a circuit comprising multiple hardware devices configured such that the probabilistic weight distribution can be mapped onto the noise associated with the circuit.

16. The hardware system of claim 14, wherein one or more control operations are performed on a given hardware device for the given synapse to adjust the noise associated with the given hardware device to match the probabilistic weight distribution for the given synapse.

17. A method of operating a hardware system including a neural network, the neural network comprising nodes interconnected by respective synapses implemented by respective hardware devices, the hardware system generating an output by performing an inference operation using the neural network, the method comprising:
controlling operation of the respective synapses by setting a physical property of the respective hardware devices implementing the respective synapses, at least one of setting the physical property or reading the physical property being subject to noise;
associating probabilistic weight distributions with the respective synapses, wherein setting the physical property of a given hardware device implementing a given synapse comprises applying a weight value sampled from the probabilistic weight distribution corresponding to the given synapse;
performing the inference operation by performing multiple inference determinations using multiple respective sampled weight values for the respective synapses to obtain multiple inference results, the multiple inference results indicating a confidence interval for the output of the inference operation.

18. A hardware system for training a neural network, the neural network comprising nodes interconnected by respective synapses implemented by respective hardware devices in the hardware system;
wherein operation of the respective synapses is controlled by setting a physical property of the respective hardware devices implementing the respective synapses, at least one of setting the physical property or reading the physical property being subject to noise;
wherein the neural network associates probabilistic weight distributions with the respective synapses, wherein setting the physical property of a given hardware device implementing a given synapse comprises applying a weight value sampled from the probabilistic weight distribution corresponding to the given synapse;
and wherein the hardware system maps the probabilistic weight distribution to the noise of setting the physical property or reading the physical property, and to implement sampling from the probabilistic weight distribution by setting the physical property or reading the physical property subject to the noise.

19. The hardware system of claim 18, wherein the neural network comprises:
a spiking neural network with binary spikes or multi-valued spikes: or a Bayesian.

20. (canceled)

21. (canceled)

22. The hardware system of claim 18, wherein the weight values are binary or Gaussian.

23. (canceled)

24. The hardware system of claim 18, wherein the hardware system is configured as a crossbar array that comprises multiple cores, wherein each core comprises a set of input nodes connected to a set of output nodes such that each input node of the set of input nodes has a separate connection to each output node of the set of output nodes via a given synapse.

25. (canceled)

26. (canceled)

27. (canceled)

28. The hardware system of claim 18, wherein a given synapse is formed from a circuit comprising multiple hardware devices configured such that the probabilistic weight distribution can be mapped onto the noise associated with the circuit.

29. The hardware system of claim 18, wherein one or more control operations are performed on a given hardware device for a given synapse to adjust the noise associated with the given hardware device to match the probabilistic weight distribution for the given synapse.

30. (canceled)

31. A method of operating a hardware system to train a neural network, the neural network comprising nodes interconnected by respective synapses implemented by respective hardware devices in the hardware system, the method comprising:
controlling operation of the respective synapses by setting a physical property of the respective hardware devices implementing the respective synapses, at least one of setting the physical property or reading the physical property being subject to noise;
associating probabilistic weight distributions with the respective synapses, wherein setting the physical property of a given synapse comprises applying a weight value sampled from the probabilistic weight distribution corresponding to thatthe given synapse; and
mapping the probabilistic weight distribution to the noise of setting the physical property or reading the physical property, and sampling from the probabilistic weight distribution by setting the physical property or reading the physical property subject to the noise.
